(19) United States
(12) Patent Application Publication
(10) Pub. No.: US 2026/0028016 A1
(43) Pub. Date: Jan. 29, 2026

(54) SYSTEM AND METHOD FOR SELECTING A SHIFT SCHEDULE FOR A HYBRID VEHICLE

(71) Applicant: Caterpillar Inc., Peoria, IL (US)

(72) Inventor: Kyle P. HEWERDINE, Chillicothe, IL (US)

(73) Assignee: Caterpillar Inc., Peoria, IL (US)

(21) Appl. No.: 18/784,047

(22) Filed: Jul. 25, 2024

(51) Int. Cl. B60W 20/30

(52) U.S. Cl. CPC B60W 20/30; B60W 2510/244; B60W 2520/10

(57) ABSTRACT

A system and method for selecting a shift schedule of a hybrid vehicle. The hybrid vehicle includes a hybrid powertrain having a motor-generator unit, a battery electrically connected to the motor-generator unit an engine, and a transmission engageably connected to the engine and the motor-generator unit. The hybrid vehicle also includes a controller for controlling the hybrid powertrain. Upon reaching a trigger speed, the controller is configured to select a shift schedule from a plurality of shift schedules, based on a state of charge of the battery.

### TECHNICAL FIELD

The present disclosure relates generally to hybrid vehicles, and more particularly, to a system and method for selecting a shift schedule for a hybrid vehicle.

### BACKGROUND

Shift schedules are used to by vehicles to determine when a transmission should upshift or downshift. Traditional vehicles with only internal combustion engines may have shift schedules with two degrees of freedom, the amount a pedal is depressed and the speed of the vehicle or engine. Hybrid vehicles may have shift schedules with additional degrees of freedom, particularly the state of charge of the battery. For both traditional vehicles and hybrid vehicles, the shift schedules are often designed to optimize performance through the entire operational range of the vehicle, which may result in inefficiencies.

U.S. Patent Application Publication No. 9,783,183, published on Oct. 10, 2017 (“the '183 publication”), describes a vehicle having a shift schedule that connects and disconnects certain elements of gear sets to control the ratio between a transmission output shaft and a transmission input shaft. A gearbox is automatically shifted from one ratio to another based on various vehicle and ambient operating conditions by an associated controller, such as a powertrain control unit. The shift schedule can have shift points (e.g., points at which a shift is commanded) based on both driver demand and the rotational speed of the transmission input shaft. To reduce unwanted downshifts, the controller may be programmed to command an amount of negative torque (charging) that exceeds the driver demanded torque, but will not cause the transmission gearbox to downshift to accommodate for the charging. However, the '183 does not describe the use of a triggering event for enabling multiple shift schedules around a specified speed.

The system and method for selecting a shift schedule for a hybrid vehicle of the present disclosure may solve one or more of the problems set forth above and/or other problems in the art. The scope of the current disclosure, however, is defined by the attached claims, and not by the ability to solve any specific problem.

### SUMMARY

In one aspect, the disclosure relates to a hybrid vehicle, the hybrid vehicle including a hybrid powertrain and a controller for controlling the hybrid powertrain. The hybrid powertrain may includes a motor-generator unit, a battery electrically connected to the motor-generator unit an engine, and a transmission engageably connected to the engine and the motor-generator unit. Upon reaching a trigger speed, the controller may be configured to select a shift schedule from a plurality of shift schedules, based on a state of charge of the battery.

In some aspects, the techniques described herein relate to a method of selecting a shift schedule for a hybrid vehicle, the method including the step of obtaining a trigger speed by the hybrid vehicle. The hybrid vehicle may include a controller and a hybrid powertrain. The hybrid powertrain includes a motor-generator unit, a battery electrically connected to the motor- generator unit, an engine, and a transmission engageably connected to the engine and the motor- generator unit. The method further includes the steps of determining a state of charge of the battery, and selecting, upon obtaining the trigger speed, one of a plurality of shift schedules based on the state of charge of the battery.

In some aspects, the techniques described herein relate to a controller for a hybrid vehicle, the controller configured to determine if the hybrid vehicle has obtained a trigger speed. The hybrid vehicle may include a motor-generator unit, a battery electrically connected to the motor-generator unit, an engine, and a transmission engageably connected to the engine and the motor-generator unit. The controller may be further configured to determine a state of charge of the battery and select, upon obtaining the trigger speed, one of a plurality of shift schedules based on the state of charge of the battery.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a hybrid vehicle, according to aspects of the disclosure.

FIG. 2 is a schematic diagram of a powertrain of the hybrid vehicle of FIG. 1.

FIG. 3 is a schematic diagram of a control system of the hybrid vehicle of FIG. 1.

FIG. 4 provides a flowchart depicting an exemplary method for selecting a shift schedule for a hybrid vehicle.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of +10% in the stated value.

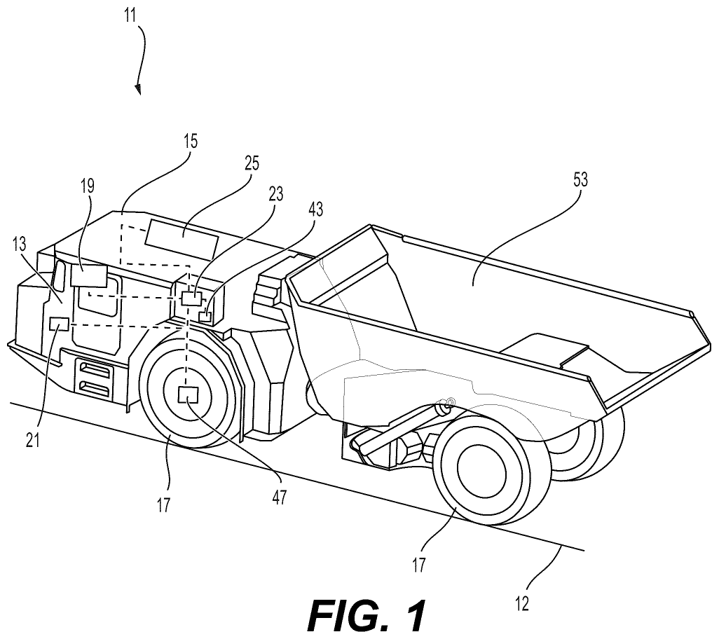

FIG. 1 depicts a hybrid vehicle 11, according to aspects of the disclosure. They hybrid vehicle 11 may include a hybrid powertrain 25, including a motor-generator unit (“MGU”) 27, a battery 29, an engine 31, and a transmission 35 having gears 39. The hybrid vehicle 11 may have a controller 23 that dynamically selects a shift schedule for the vehicle according to the state of charge of the battery and motor boosting capabilities once a specified speed has been obtained.

As shown in FIG. 1, the hybrid vehicle 11 may include a cab 13, a housing 15, and ground engaging elements 17. Within the cab 13, the hybrid vehicle 11 may include a user interface 19 and one or more control elements, for example, pedals 21. The user interface 19 may be a touch screen device, switches, or another appropriate interface(s) for receiving user input. The pedals 21 may include one or more of an accelerator pedal, a brake pedal, or a clutch pedal, depending on the vehicle. Within the housing 15 may be the hybrid powertrain 25, described in more detail below. The hybrid vehicle 11 may further include a controller 23 in electronic communication with the user interface 19, the pedals 21, and the hybrid powertrain 25. The hybrid vehicle 11 may further include an inertial measurement unit (“IMU”) 43 and a wheel speed sensor 47, which may both be mounted on or near one or more ground engaging elements 17 of the hybrid vehicle 11. The IMU 43, the wheel speed sensor 47, and other sensors described below may also be in electronic communication (e.g., via one or more wired or wireless connections) with the controller 23.

FIG. 1 depicts the hybrid vehicle 11 as an articulated haul truck, for example, including a bed 53. Additionally, the ground engaging elements 17 are depicted as tires. In other examples, the hybrid vehicle 11 may be another type of large vehicle, such as a heavy duty truck, a bus, a track type vehicle, a mining vehicle, etc. Furthermore, in some examples, the ground engaging elements 17 may be another suitable vehicle propulsion system, such as one or more tracks (e.g., continuous track treads).

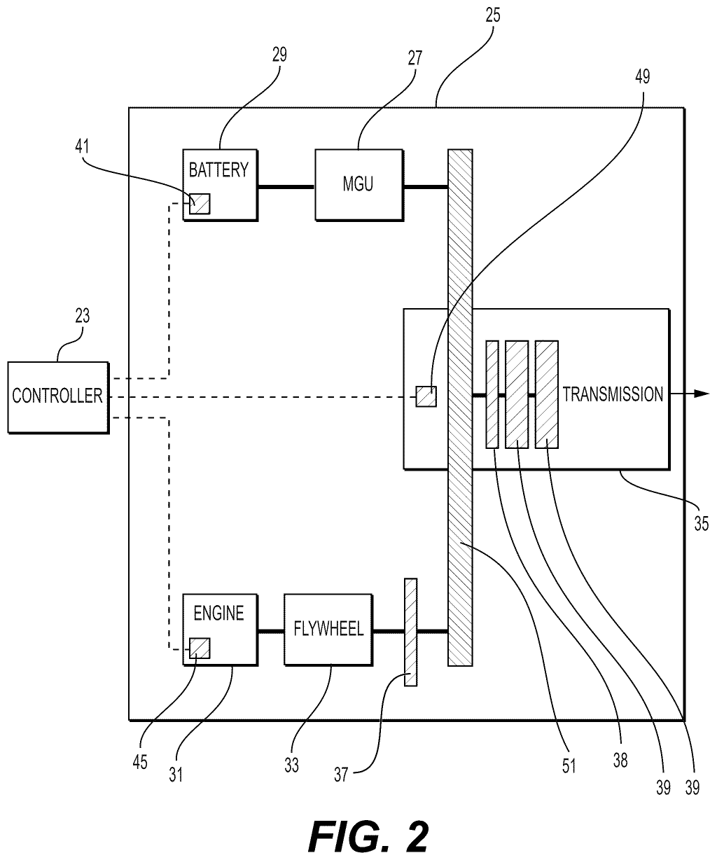

FIG. 2 is a diagram of the hybrid powertrain 25 of the hybrid vehicle of FIG. 1. The battery 29 may be electrically connected to the MGU 27, which may allow power or energy to flow between the battery 29 and the MGU 27, for example, in either direction. The flywheel 33 may be rotatably connected to the engine 31 via a crankshaft (not shown). The flywheel 33 may be engageably and rotatably connected to one or more shaft(s) 51 by a clutch 37. The shaft(s) 51 may extend between the clutch 37 and the MGU 27, and the shaft(s) 51 may connect both the engine 31 and the MGU 27 to the transmission 35.

The transmission 35 may output power received from the MGU 27, the engine 31, or both to the ground engaging elements 17 (FIG. 1). The transmission 35 may include a number of clutches 38 and gears 39. The clutches 38 may interact with the gears 39 in order to select or change the gears 39 being driven by the MGU 27 or the engine 31.

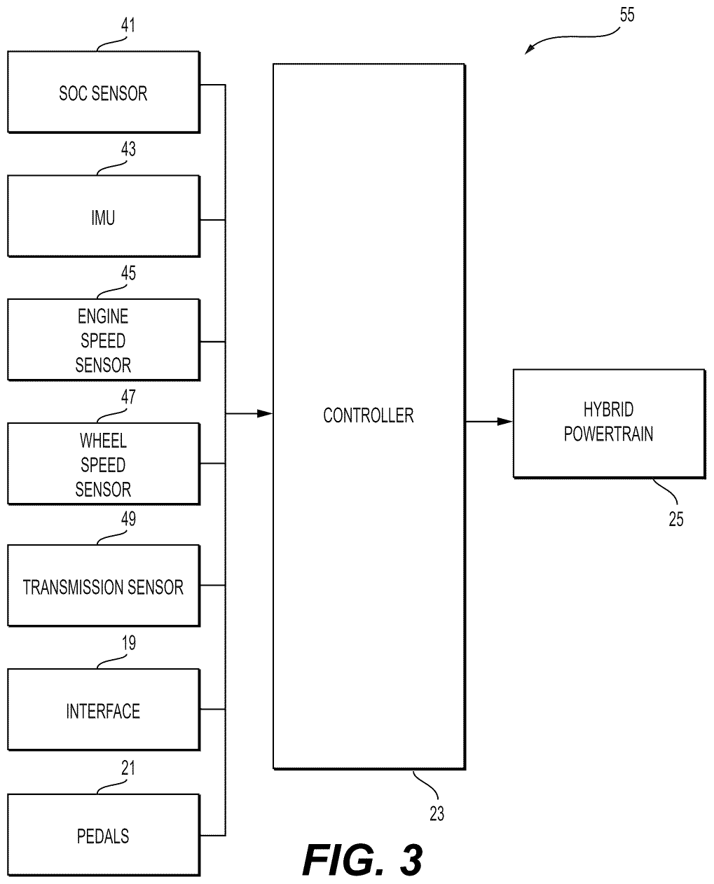

FIG. 3 is a diagram of a control system 55 of the hybrid vehicle of FIG. 1. The control system 55 may include the controller 23, the SOC sensor 41, the transmission sensor 49, the engine speed sensor 45, the wheel speed sensor 47, the IMU 43, the user interface 19, the pedals 21, the hybrid powertrain 25, as well as other sensors and components. As shown in FIG. 3, the controller 23 of the control system 55 may receive one or more inputs from one or more of the SOC sensor 41, the IMU 43, the engine speed sensor 45, the wheel speed sensor 47, the transmission sensor 49, the user interface 19, or the pedals 21. The inputs may include the value or other information measured by the sensors, for example, the state of charge of the battery 29 as measured by the SOC sensor 41, the slope or grade of the terrain 12 upon which the hybrid vehicle 11 is operating as measured or determined by the IMU 43, the speed of the engine 31 as measured by the engine speed sensor 45, the speed of the hybrid vehicle 11 as measured by the wheel speed sensor 47, or the current gear 39 or speed of the transmission 35 as measured or determined by transmission sensor 49. The inputs may also include values input by a user, such as representative values of selections made by a user at the user interface 19, or the value of the amount a user depresses one of the pedals 21. The controller 23 may also send one or more outputs to one or more components of the hybrid powertrain 25, for example, to the transmission 35. The outputs may include, among other things, instructions to the transmission 35 on when to shift gears 39 based on a shift schedule computed or stored by the controller 23.

The controller 23 may be a control module that controls one or more aspects of the hybrid vehicle 11, including for example, the hybrid powertrain 25. The controller 23 may be a single controller configured to control the hybrid vehicle 11. If desired, the controller 23 may be a single controller dedicated to one or more aspects of the hybrid vehicle 11 or combustion engine 200. As used herein the term “controller,” while singular, includes both a single controller and multiple controllers that operate with the hybrid vehicle 11. Thus, the controller 23 may be implemented as a plurality of distributed control modules in communication with each other. The controller 23 may be enabled, via programming, to receive inputs (e.g., from SOC sensor 41) generate outputs (e.g., a gear 39 of the transmission 35).

The controller 23 may embody a single microprocessor or multiple microprocessors that receive inputs or generate outputs. The controller 23 may include a memory, as well as a secondary storage device, a processor, such as a central processing unit, or any other means or devices for accomplishing a task consistent with this disclosure. The memory or secondary storage device associated with the controller 23 may store data and software to allow the controller 23 to perform its functions, including the functions described herein. In particular, the memory for the controller 23 may store instructions that, when executed by one or more processors, enable these processors to perform one or more of the functions described herein. Numerous commercially available microprocessors can be configured to perform the functions of the controller 23. Various other known circuits may be associated with the controller 23, including signal-conditioning circuitry, communication circuitry, and other appropriate circuitry.

During operation, the controller 23 may the monitor one or more of the inputs to determine when the hybrid vehicle 11 has reached a trigger speed, at which point, the controller may automatically select a shift schedule from a plurality of shift schedules. The trigger speed may be a convoy speed, also referred to as a cruising speed. The convoy speed may be a speed at which the hybrid vehicle 11 is designed or desired to maintain for long periods of time. In some examples, the convoy speed may be a speed at which the hybrid vehicle 11 is optimized to travel at for long periods of time. In other examples, the convoy speed may be an arbitrarily selected speed that is stored in the controller 23 or input by a user, for example, at the user interface 19. The trigger speed may also be higher or lower than the convoy speed, such that the controller may select the shift schedule before or after the hybrid vehicle 11 reaches convoy speed.

Before reaching the trigger speed, the shift schedule may be static, such that there is only one shift schedule before reaching the trigger speed. After reaching the trigger speed, the controller 23 may automatically select or change the shift schedule based on the state of charge of the battery 29, the ability of the MGU 27 to provide additional torque or power (referred to as providing boost), and optionally the drive mode selected or the slope or grade of the terrain 12. For example, the controller 23 may select a first shift schedule when the battery 29 is at a first state of charge, and the controller 23 may select a second shift schedule when the battery 29 is at a second state of charge (e.g., with the second state of charge being different from the first state of charge). Likewise, for a particular state of charge, the controller may select a first shift schedule when the MGU 27 is able to provide boost, and a second shift schedule when the MGU 27 is unable to provide boost. The controller 23 may also select a different shift schedule in a first drive mode than the shift schedule selected in a second drive mode.

The shift schedule may determine when the transmission switches gears 39. For example, the shift schedule may include conditions for when the transmission should select a lower gear 39 (e.g., downshift) or select a higher gear 39 (e.g., upshift). For example, the shift schedule may comprise a list of speeds at which an upshift or downshift should occur for a given amount of depression of accelerator pedal 21. In some examples, the speeds may be vehicle speeds of the hybrid vehicle 11, and in other examples, the speeds may be engine speeds of the engine 31.

For hybrid vehicle 11, a different shift schedule may be created for different states of battery charge, such that the hybrid vehicle 11 shifts gears 39 at a different rate or speed for a different states of charge and the same amount of accelerator depression. Put another way, the shift schedules may be such that the hybrid vehicle 11 shifts at a different amounts of depression of the pedals 21 for different states of charge and a constant speed (e.g., vehicle speed or engine speed).

In some examples, as the amount the pedal 21 is depressed increases, the speed at which a shift point occurs for a given state of charge increases. This may allow the engine 31 to produce higher torque levels for increased pedal depressions. In such examples, the downshift points may occur at a lower speed than the upshift points for a given amount of accelerator depression. Additionally, as the state of charge of the battery 29 decreases, the speed at which a shift point occurs for a given amount of pedal depression also increases. This may allow the engine 31 to operate at a higher torques for a given amount of pedal depression and vehicle speed as the state of charge decreases in order to supply additional charge to the battery 29 via the MGU 27. Put another way, for a specified engine speed, the likelihood of a downshift occurring may increase as the state of charge of the battery decreases.

In some examples, after reaching the trigger speed, the shift schedules may be optimized at or around the convoy speed in order to help minimize or optimize the engine speed while avoiding unnecessary gear shifts. For example, the shift schedule may be such that a downshift occurs only for a high degree of pedal depression while at convoy speed, which may increase fuel efficiency and limit gear shifting. In such examples, the MGU 27 may provide boost to maintain the convoy speed in the higher gear 39 than would otherwise be selected by the controller 23. In such examples, as the state of charge of the battery 29 depletes, the downshift points of the shift schedules for the progressively lower states of charge may occur at increasingly lower amounts of pedal depression. This may help to allow the downshifts to occur sooner when the MGU 27 is no longer able to provide the necessary boost needed to maintain the convoy speed.

In some examples, the controller 23 may also select or change shift schedules based on the slope of the terrain 12. When the hybrid vehicle is operating on a steep terrain while moving, for example, uphill, the controller 23 may select shift schedules that avoid unnecessary gear shifts while accounting for the additional burden on the powertrain 25 needed to maintain convoy speed. Such shift schedules may adjust the shift points such that shifts occurs at lesser amounts of pedal depression for a given speed.

In some examples, the user may select one of a plurality of drive modes, with each drive mode having its own set of shift schedules that the controller 23 may select after the hybrid vehicle 11 reaches a trigger speed. The drive modes may include one or more of a hybrid drive mode, a hybrid performance drive mode, or a mechanical drive mode, and the user may select one of the drive modes from the user interface 19. In other examples, the user may select the drive mode in a different manner, and may select a different drive mode from those listed.

In the hybrid drive mode, the powertrain 25 may use either or both of the engine 31 or the MGU 27, and use a first set of shift schedules. In the hybrid performance drive mode, the powertrain 25 may also use either or both of the engine 31 or the MGU 27, with a second set of shift schedules that are more aggressively tuned such that shifts occur at a tighter range (e.g., more frequent shifts) to enhance the performance of the hybrid vehicle 11. For example, for a given battery state and vehicle speed, the shift points may occur in a larger band around the designated speed for the hybrid performance mode to allow for a greater range of capability. In the mechanical drive mode, the powertrain 25 may use the engine 31, but not the MGU 27 to provide power to the hybrid transmission 35. In the mechanical drive mode, the controller 23 may select a shift schedule that is not dependent on the state of charge of the battery and which may or may not be different from the shift schedule that the controller utilizes before reaching the trigger point.

### Industrial Applicability

The disclosed aspects of the invention of the present disclosure may be used to optimize hybrid vehicle performance around a convoy speed.

Aspects of this disclosure may allow for selection of shift schedules, which may help to optimize the efficiency or performance of the hybrid vehicle 11 around maintaining a convoy speed. By optimizing the shift schedules around the convoy speed, the shift schedules may be easily tuned to obtain greater efficiency. Further, optimization of shift schedules around the convoy speed may help to prevent unnecessary shifting, which may thus help to improve the performance, durability, lifetime, etc. of various aspects of the hybrid vehicle 11, for example, including the transmission 35.

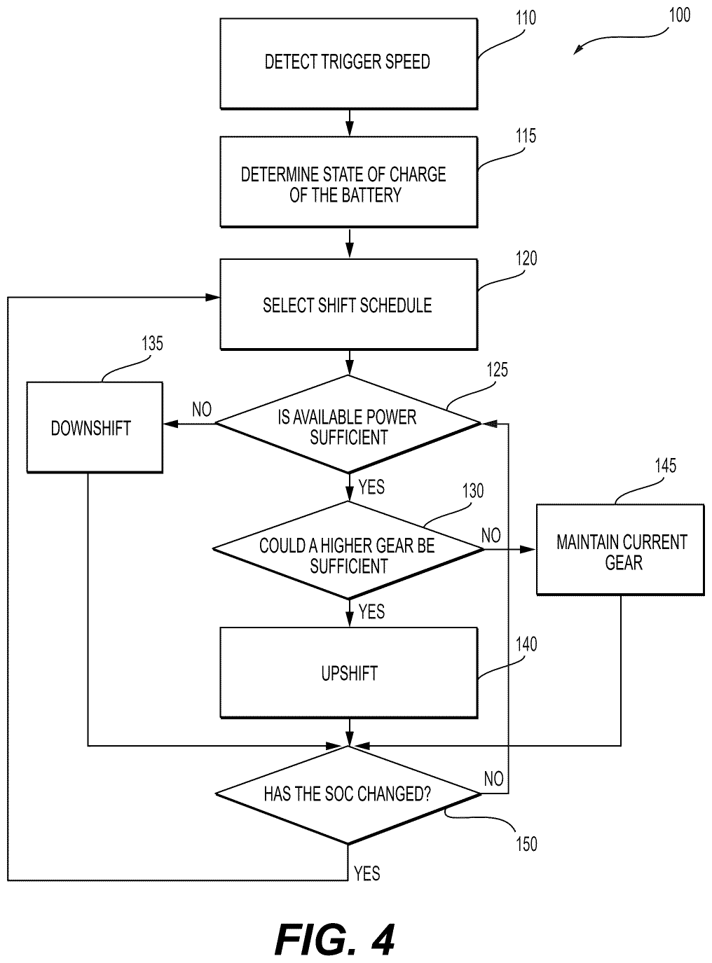

FIG. 4 is flowchart of a method 100 of operating a vehicle having a hybrid powertrain. In a step 110, the controller 23 determines that the hybrid vehicle 11 has obtained a trigger speed. As mentioned above, the trigger speed may be a convoy speed. At a step 115, the controller 23 determines the state of charge of the battery 29. At a step 120, the controller 23 selects a shift schedule based on the state of charge of the battery 29. At a step 125, the controller 23 determines if the power or torque available from the powertrain 25 is sufficient to maintain the vehicle speed. If the power or torque available is sufficient, then at a step 130, the controller 23 determines if a higher gear may provide sufficient power or torque to maintain the vehicle speed. If a higher gear provides sufficient power, then at a step 135, the controller 23 causes the transmission 35 to upshift. If the higher gear does not provide sufficient power, then the controller 23 maintains the current gear.

If the available power had been insufficient, then at step 135 the controller 23 causes or signals the transmission 35 to downshift. At a step 150, the controller 23 determines if the state of charge of the battery has changed. If the state of charge has changed, then method 100 returns to step 120 and the controller 23 selects a new shift schedule. If the state of charge has not changed, then the method returns to step 125 and the controller 23 determines if the available power or torque is sufficient to maintain the vehicle speed. Method 100 may be continuously performed during the operation of the hybrid vehicle 11, for example, while operating at or around the trigger speed (e.g., the convoy speed). Method 100 and various aspects discussed herein may help to allow hybrid vehicle 11 to optimize the efficiency or performance of the hybrid vehicle 11 by optimizing the shift schedules around a convoy speed. Optimization of shift schedules around the convoy speed may help to prevent unnecessary shifting, which may thus help to improve the performance, durability, lifetime, etc. of various aspects of the hybrid vehicle 11, for example, including the transmission 35.

It will be apparent to those skilled in the art that various modifications and variations can be made to the disclosed system, vehicle, and method of operation without departing from the scope of the disclosure. Other embodiments of the system, vehicle, and method of operation will be apparent to those skilled in the art from consideration of the specification and practice of the system, vehicle, and method of operation disclosed herein. It is intended that the specification and examples be considered as exemplary only, with a true scope of the disclosure being indicated by the following claims and their equivalents.

What is claimed is:

1. A hybrid vehicle, the hybrid vehicle comprising:
a hybrid powertrain including:
a motor-generator unit;
a battery electrically connected to the motor-generator unit
an engine; and
a transmission engageably connected to the engine and the motor-generator unit, and
a controller for controlling the hybrid powertrain,
wherein, upon reaching a trigger speed, the controller is configured to select a shift schedule from a plurality of shift schedules, based on a state of charge of the battery.

2. The hybrid vehicle of claim 1, further comprising an inertial measurement unit, and wherein the controller is configured to measure a grade or slope of a terrain on which the vehicle is operating based on information from the inertial measurement unit, and wherein the selection of the shift schedule by the controller is further based on the grade or slope of the terrain on which the vehicle is operating.

3. The hybrid vehicle of claim 1, wherein the trigger speed is a convoy speed.

4. The hybrid vehicle of claim 1, wherein the plurality of shift schedules includes a mechanical shift schedule, a hybrid shift schedule, and a hybrid performance shift schedule.

5. The hybrid vehicle of claim 1, further comprising a user interface, and wherein one of a plurality of drive modes is selectable from the user interface.

6. The hybrid vehicle of claim 5, wherein the controller is configured to adjust the shift schedule based on a drive mode selected from the user interface.

7. The hybrid vehicle of claim 1, wherein the controller selects one of the plurality of shift schedules, and when the hybrid vehicle is above the trigger speed, the controller changes the shift schedule based on changes to the state of charge of the battery.

8. The hybrid vehicle of claim 1, further comprising an engine speed sensor.

9. The hybrid vehicle of claim 1, wherein the battery includes a state of charge sensor connected to the controller.

10. A method of selecting a shift schedule for a hybrid vehicle, the method comprising the steps of:
obtaining a trigger speed by the hybrid vehicle, the hybrid vehicle having a controller and a hybrid powertrain, wherein the hybrid powertrain includes:
a motor-generator unit;
a battery electrically connected to the motor-generator unit;
an engine; and
a transmission engageably connected to the engine and the motor-generator unit; and
determining a state of charge of the battery; and
selecting, upon obtaining the trigger speed, one of a plurality of shift schedules based on the state of charge of the battery.

11. The method of claim 10, further comprising the step of determining a grade or slope of a terrain on which the hybrid vehicle is operating, and wherein the selecting one of the plurality of shift schedules is further based on the grade or slope of the terrain on which the hybrid vehicle is operating.

12. The method of claim 11, wherein the hybrid vehicle further includes an inertial measurement unit for measuring the grade or slope of the terrain.

13. The method of claim 10, wherein the trigger speed is a convoy speed.

14. The method of claim 10, wherein the method includes selecting a drive mode from a plurality of drive modes, each drive mode including a different set of shift schedules, wherein the drive modes include mechanical shift schedule, a hybrid shift schedule, and a hybrid performance shift schedule.

15. The method of claim 14, wherein the hybrid vehicle further includes a user interface, and wherein the drive mode is selectable from the user interface.

16. The method of claim 10, wherein the controller selects one of the plurality of shift schedules, and when the hybrid vehicle is above the trigger speed, the controller changes the shift schedule based on the state of charge of the battery.

17. A controller for a hybrid vehicle, the controller configured to:
determine if the hybrid vehicle has obtained a trigger speed, the hybrid vehicle including:
a motor-generator unit,
a battery electrically connected to the motor-generator unit,
an engine, and
a transmission engageably connected to the engine and the motor-generator unit;
determine a state of charge of the battery; and
select, upon obtaining the trigger speed, one of a plurality of shift schedules based on the state of charge of the battery.

18. The controller of claim 17, wherein the controller is further configured to determine a grade or slope of a terrain on which the vehicle is operating, and select one of the plurality of shift schedules based in part on a grade or slope of the terrain on which the vehicle is operating.

19. The controller of claim 17, wherein the controller is configured to select between sets of shifts schedules depending on a drive mode selected, wherein the drive modes include a mechanical drive mode, a hybrid drive mode, and a hybrid performance drive mode.

20. The controller of claim 17, wherein the controller selects one of the plurality of shift schedules, and when the hybrid vehicle is above the trigger speed, the controller changes the shift schedule based on changes to the state of charge of the battery.
